(19) United States
(12) Patent Application Publication
(10) Pub. No.: US 2017/0270308 A1
(43) Pub. Date: Sep. 21, 2017

(54) SECURITY DEVICE AND CONTROL METHOD

(71) Applicant: FUJITSU LIMITED, Kawasaki-shi (JP)

(72) Inventors: HIROSHI NAKAYAMA, Kawasaki (JP); Kiyoshi Kohiyama, Toshima (JP)

(73) Assignee: FUJITSU LIMITED, Kawasaki-shi (JP)

(21) Appl. No.: 15/611,200

(22) Filed: Jun. 1, 2017

Related U.S. Application Data
(63) Continuation of application No. PCT/JP2014/082330, filed on Dec. 5, 2014.

(51) Int. Cl. G06F 21/60; G06F 21/72; G06F 3/06; H04L 9/14; H04L 9/06

(52) U.S. Cl. CPC G06F 21/602; H04L 9/14; H04L 9/0643; G06F 3/0623; G06F 3/0659; G06F 3/0683; G06F 21/72

(57) ABSTRACT

A secure area includes a processor that is included in a secure area and a first memory with storage capacity less than a predetermined amount. The processor decrypts, when encrypted first information and encrypted second information are input from a secret input path, the first information and the second information and stores the first information in the first memory. The processor encrypts, by using an encryption key obtained based on the decrypted first information, the decrypted second information and makes a request to store the encrypted second information in a second memory that is present outside the secure area.

### CROSS-REFERENCE TO RELATED APPLICATION

This application is a continuation of International Application No. PCT/JP2014/082330, filed on Dec. 5, 2014, the entire contents of which are incorporated herein by reference.

### FIELD

The embodiments discussed herein are directed to a security device and the like.

### BACKGROUND

Conventionally, a secure area in which encrypted digital audio and visual (AV) information is decrypted is referred to as a conditional access system (CAS) or digital rights management (DRM). In a case of CAS, the secure area is implemented in the form of card. In a case of DRM, a secure portion is created and implemented in a part of software that is processed by a host CPU in a terminal.

CAS and DRM secretly receive a decryption key that basically decrypts encrypted digital AV information via broadcasting or communication and allow the digital AV information to be decrypted by a receiving terminal.

FIG. 20 is a schematic diagram illustrating an example of a process performed by using a CAS technique. A broadcast station 5 encrypts the original digital AV information by a scramble key Ks and superimposes the encrypted information onto broadcasting digital stream. The broadcast station 5 encrypts the scramble key Ks by a work key Kw, inserts the encrypted scramble key Ks into the packet called an ECM, and multiplexes the ECM in a time division manner into the broadcasting digital stream. Furthermore, the broadcast station 5 encrypts the work key Kw by a master key Km, inserts the encrypted work key Kw into the packet called an EMM, and multiplexes the EMM in a time division manner into the broadcasting digital stream. Here, the master key Km is a key that is only known by the broadcast station 5 and an individual viewer.

If a receiving terminal 10 receives the broadcasting digital stream from the broadcast station 5, the receiving terminal 10 inputs the ECM and the EMM included in the broadcasting digital stream to a smart card 30. By decrypting EMM by the master key Km stored in the smart card 30, the smart card 30 acquires the work key Kw and stores the acquired work key Kw in the smart card. The smart card 30 acquires the scramble key Ks by decrypting the ECM using the work key Kw. The smart card 30 outputs the scramble key Ks to the main body of the receiving terminal 10. The receiving terminal 10 decrypts, by using the scramble key Ks, the encrypted digital AV information.

The CAS technique performed by using the master key, the work key, and the scramble key described with reference to FIG. 20 is referred to as a triple key technique. The master key is a unique key, i.e., one and only one unique key provided to each individual viewer, and a right to view a TV program is provided to the individual viewer by this master key. Namely, the broadcast station 5 provides a right of a work key for each viewer by sending the work key that is encrypted by the master key that is only held by the subject viewer.

A method of using the work key is not limited but is used, in general, to provide a view right with respect to a predetermined channel. For example, in order to provide a view right of a pay broadcasting channel to a contract viewer, the broadcast station 5 sends the work key that is encrypted by the master key to the receiving terminal 10.

The scramble key is used to encrypt digital AV information on a channel. For example, if a viewer views a pay broadcasting channel, the scramble key is decrypted by the work key related to the pay broadcasting channel and the encrypted digital AV information is decrypted by using the decrypted scramble key.

In the following, the configuration of a receiving terminal will be described. FIG. 21 is a schematic diagram illustrating the configuration of a conventional receiving terminal. As illustrated in FIG. 21, the receiving terminal 10 includes a system large-scale integrated circuit (LSI) 11. The system LSI 11 includes a main central processing unit (CPU) 12, a random access memory (RAM) 13, a non-volatile memory (NVRAM) 14, a Tuner 15, an encryption/decryption circuit 16, a decompression processing circuit 17, and a graphic circuit 18. Furthermore, the receiving terminal 10 is connected to a display device 6 and the smart card 30. Each of the devices 12 to 18 is connected to a bus 19.

The main CPU 12 is a device that performs overall control of the receiving terminal 10. The main CPU 12 performs various kinds of processes and performs control by executing various kinds of processing programs stored in the RAM 13. The NVRAM 14 is a nonvolatile memory and is an area in which information can be held even if a power supply of the receiving terminal 10 is turned off.

In accordance with an instruction of a specific program processed by the main CPU 12, each of the devices included in the receiving terminal 10 performs the processes below. The Tuner 15 receives digital AV information that is encrypted and that is transmitted on a radio wave from the broadcast station 5. The Tuner 15 outputs the information on an ECM and an EMM included in the encrypted digital AV information to the smart card 30.

If the smart card 30 receives the EMM, the smart card 30 decrypts the EMM by using the master key Km stored in the smart card 30 and extracts the work key Kw. The smart card 30 stores the extracted work key Kw in a small area nonvolatile memory in the smart card 30.

If the smart card 30 receives the ECM, the smart card 30 decrypts the ECM by using the work key Kw that is stored in the small area nonvolatile memory and then extracts the scramble key Ks. The smart card 30 outputs the extracted scramble key Ks to the main CPU 12.

The main CPU 12 inputs the scramble key Ks received from the smart card 30 to the encryption/decryption circuit 16. The encryption/decryption circuit 16 decrypts the encrypted digital AV information and outputs the decrypted digital AV information to the decompression processing circuit 17. The decrypted digital AV information has been subjected to, for example, Moving Picture Experts Group (MPEG) compression.

The decompression processing circuit 17 decompresses the digital AV information that has been subjected to the MPEG compression. For example, by being decompressed, the digital AV information becomes a digital Red-Green-Blue (RGB) signal and a digital audio signal. The digital RGB signal is input to the graphic circuit 18. The graphic circuit 18 displays the image information associated with the digital RGB signal on the display device 6.

Here, for example, if software running on the main CPU 12 is hacked, the master key Km and the work key Kw may possibly be stolen. If the software is hacked, the software is altered without warning and the master key Km or the work key Kw in the smart card 30 is copied without warning. If so, the master key Km or the work key Kw may possibly be opened to the public to the Internet and, in some cases, a pay broadcasting channel can be viewed by anybody without permission.

The smart card 30 stores the master key Km in the dedicated nonvolatile memory so as not to easily peep or alter from the main CPU 12. Consequently, even if the software running on the main CPU 12 is hacked, it is possible to prevent the work key Kw decrypted by the master key Km or the master key Km from leaking outside.

In the following, an example of the configuration of the smart card 30 will be described. FIG. 22 is a schematic diagram illustrating the configuration of a conventional smart card. As illustrated in FIG. 22, the smart card 30 includes a CPU 31, a Boot ROM 32, a ROM 33, an NVRAM 34, a RAM 35, an encryption circuit 36, a Clock 37, and a serial IF 38. The serial IF 38 is connected to the bus 19 via a serial IF 39. The smart card 30 is covered by a card that makes peeping or alteration difficult from outside.

The CPU 31 is a device that performs overall control of the smart card 30. The Boot ROM 32 stores therein information on an initial instruction when the CPU 31 is started up. The ROM 33 stores therein, for example, a B-CAS program or a serial IF processing program. The NVRAM 34 stores therein the master key Km, the work key Kw, contract broadcast program information, and the like. The RAM 35 is a work area that is used when the CPU 31 executes various kinds of programs.

If a power supply of the smart card 30 is turned on, the CPU 31 acquires the initial instruction from the Boot ROM 32 and performs the process associated with the subject initial instruction. For example, the CPU 31 copies the B-CAS program and the serial IF processing program stored in the ROM 33 to the RAM 35 and allows the B-CAS program and the serial IF processing program to be performed. For example, the B-CAS program is a program that executes an EMM process and an ECM process, which will be described later. The serial IF processing program is a program that executes a process of sending and receiving information to and from an external unit via the serial IF 38.

If a packet is received from the serial IF 38, the CPU 31 starts up the serial IF processing program. Because the packet that is input from the serial IF 38 is serial information, the CPU 31 converts this serial information to parallel information and identifies the packet.

If the packet is an EMM, the CPU 31 performs the EMM process described below. The CPU 31 decrypts the work key Kw by extracting the master key Km from the NVRAM 34, setting the master key Km in the encryption circuit 36, and inputting the EMM to the encryption circuit 36. The CPU 31 stores the decrypted work key Kw in the NVRAM 34.

In general, the work key Kw differs for each channel. In an EMM, the channel information and the reference number of the work key Kw are included. The CPU 31 stores, in an associated manner in the NVRAM 34, the channel information, reference number, the work key Kw that are included in EMM.

If a packet is an ECM, the CPU 31 performs the ECM process described below. In the ECM, the encrypted scramble key Ks and the reference number of the work key Kw are included. The CPU 31 extracts the work key Kw associated with the reference number in the ECM from the NVRAM 34. The CPU 31 decrypts the scramble key Ks by setting the extracted work key Kw in the encryption circuit 36 and inputting the ECM to the encryption circuit 36.

After having decrypting the scramble key Ks, the CPU 31 performs serial conversion on the information on the scramble key Ks and then outputs the converted information from the serial IF 38. The scramble key Ks arrives at the main CPU 12 in the receiving terminal 10 via the serial IF 39 and the bus 19. These related-art example are described, for example, in Japanese Laid-open Patent Publication No. 2010-233222.

However, with the conventional technology described above, there is a problem in that the storage capacity of the nonvolatile memory in the secure area is small and a plurality of programs is not able to be implemented.

For example, because the storage capacity of the NVRAM 34 illustrated in FIG. 22 is small, it is difficult to cope with an increase in programs in future.

### SUMMARY

According to an aspect of an embodiment, a security device includes a processor that is included in a secure area; and a first memory with storage capacity less than a predetermined amount, wherein the processor decrypts, when encrypted first information and encrypted second information are input from a secret input path, the first information and the second information and stores the first information in the first memory, and the processor encrypts, by using an encryption key obtained based on the decrypted first information, the decrypted second information and makes a request to store the encrypted second information in a second memory that is present outside the secure area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a system LSI according to a first embodiment;

FIG. 2 is a schematic diagram illustrating a process performed by a conversion circuit group;

FIG. 3 is a schematic diagram illustrating an example of an enable circuit;

FIG. 4 is a flowchart illustrating the flow of a process performed in the system LSI according to the first embodiment;

FIG. 5 is a flowchart illustrating the flow of a process performed in a secure area according to the first embodiment;

FIG. 6 is a flowchart illustrating the flow of an initialization process performed in the secure area according to the first embodiment;

FIG. 7 is a flowchart (1) illustrating an example of a process that performs initialization;

FIG. 8 is a flowchart (2) illustrating an example of a process that performs initialization;

FIG. 9 is a schematic diagram illustrating an example of a system LSI according to a second embodiment;

FIG. 10 is a flowchart illustrating the flow of an initialization process performed in a secure area according to the second embodiment;

FIG. 11 is a flowchart (3) illustrating an example of a process that performs initialization;

FIG. 12 is a flowchart (4) illustrating an example of a process that performs initialization;

FIG. 13 is a schematic diagram illustrating an example of a system LSI according to a third embodiment;

FIG. 14 is a schematic diagram illustrating a process in which a CPU inserts a unique value into a specified area by a program;

FIG. 15 is a flowchart illustrating the flow of an initialization process performed in a secure area according to the third embodiment;

FIG. 16 is a flowchart illustrating the flow of a process performed in the secure area according to the third embodiment;

FIG. 17 is a schematic diagram illustrating an example of a system LSI according to a fourth embodiment;

FIG. 18 is a schematic diagram illustrating the data structure of ECM;

FIG. 19 is a schematic diagram illustrating a configuration example of the other system;

FIG. 20 is a schematic diagram illustrating an example of a process performed by using a CAS method;

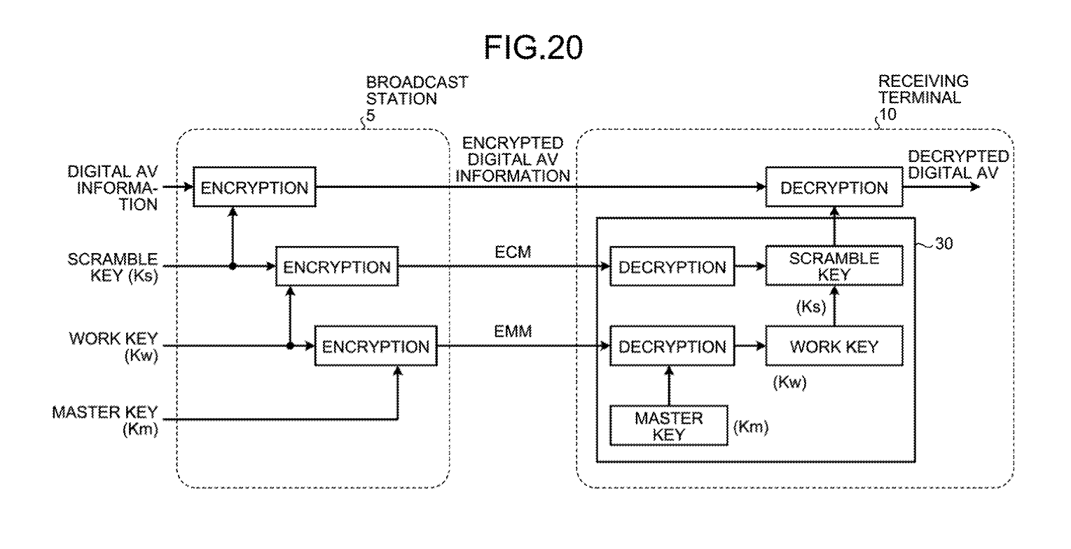

FIG. 21 is a schematic diagram illustrating the configuration of a conventional receiving terminal; and

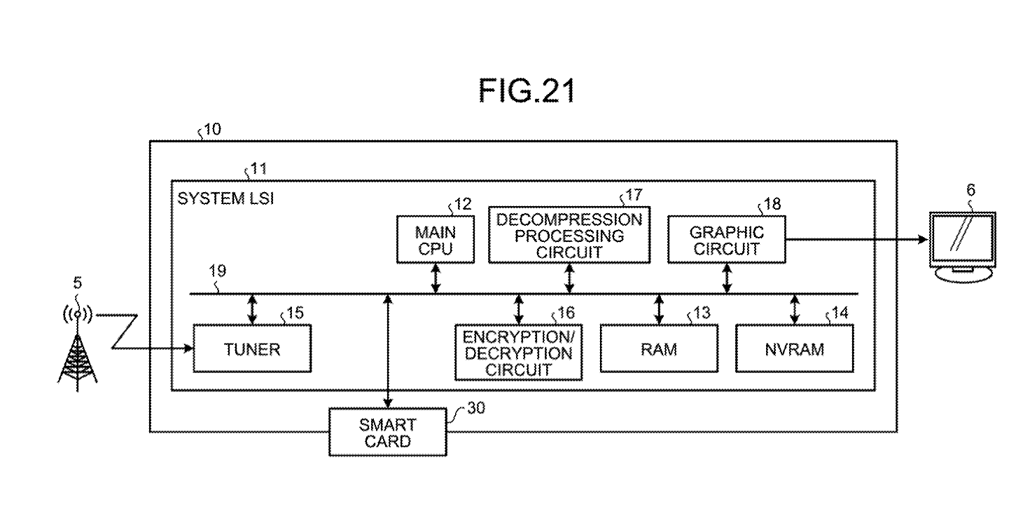

FIG. 22 is a schematic diagram illustrating the configuration of a conventional smart card.

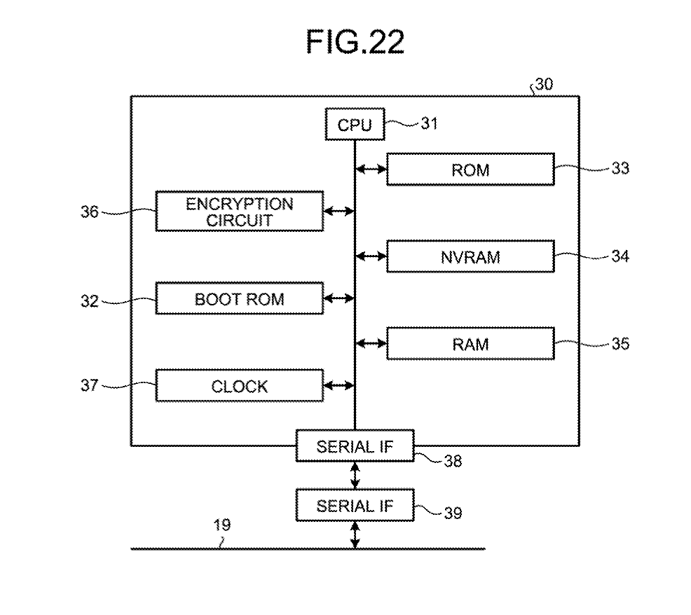

### DESCRIPTION OF EMBODIMENTS

Preferred embodiments of the present invention will be explained with reference to accompanying drawings. Furthermore, the present invention is not limited to the embodiments.

### [a] First Embodiment

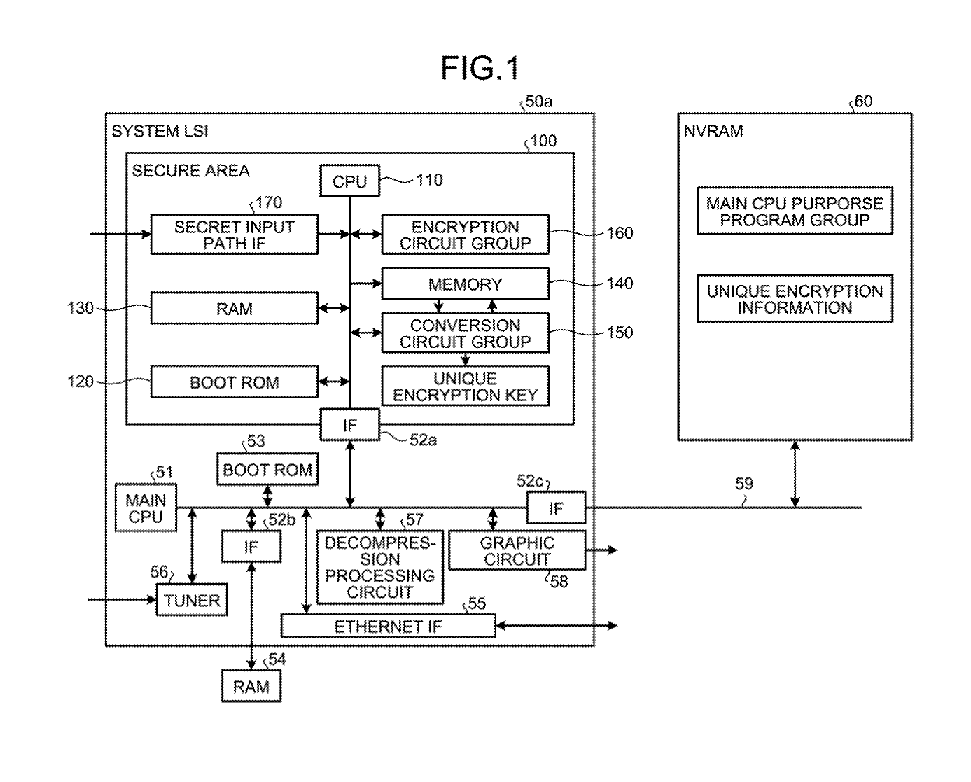

The configuration of a system LSI according to a first embodiment will be described. FIG. 1 is a schematic diagram illustrating an example of a system LSI according to first embodiment. As illustrated in FIG. 1, a system LSI 50a includes a main CPU 51, IFs 52a, 52b, and 52c, a Boot ROM 53, a RAM 54, an Ethernet (registered trademark, omitted below) IF 55, a Tuner 56, a decompression processing circuit 57, a graphic circuit 58, and a secure area 100. The system LSI 50a is connected to an NVRAM 60.

For example, the main CPU 51, the Boot ROM 53, the Ethernet IF 55, the Tuner 56, the decompression processing circuit 57, and the graphic circuit 58 are connected to a bus 59. The RAM 54 is connected to the bus 59 via the IF 52b. The secure area 100 is connected to the bus 59 via the IF 52a. In the first embodiment, an example in which the RAM 54 is connected outside the system LSI 50a via the IF 52b is described; however, the embodiment is not limited to this and the RAM 54 may also be arranged inside the system LSI 50a.

The main CPU 51 is a device that performs overall control of the system LSI 50a. If a power supply is turned on, the main CPU 51 reads an initial instruction of the Boot ROM to the RAM 54 and performs the process in accordance with the initial instruction. For example, the main CPU 51 writes, to the RAM 54 in accordance with the initial instruction, the main CPU purpose program group that is stored in the NVRAM. A program of an Operating System (OS) is included in the program group used for the main CPU.

If the main CPU 51 writes the program of the OS to the RAM 54, the main CPU 51 proceeds to the process based on the OS. For example, the main CPU 51 starts up the Ethernet IF 55, the Tuner 56, the decompression processing circuit 57, the graphic circuit 58, and the secure area 100. Each of the devices started up by the main CPU 51 performs, for example, the process described below.

The Ethernet IF 55 establishes an Internet connection and sends and receives information to and from an external device, such as a server.

The Tuner 56 acquires a multiplexing MPEG stream from the airwaves and extracts a compressed video stream from the acquired multiplexing MPEG stream. If the compressed video stream is not encrypted, the Tuner 56 outputs the compressed video stream to the decompression processing circuit 57.

The decompression processing circuit 57 decompresses the compressed video stream. For example, by being decompressed, the compressed video stream becomes a digital RGB signal and a digital audio signal. The decompression processing circuit 57 outputs the digital RGB signal to the graphic circuit 58 and outputs the audio signal to an audio circuit (not illustrated).

The graphic circuit 58 attaches graphic information to the digital RGB signal and outputs a video image. The graphic information corresponds to, for example, channel information or subtitle information.

In contrast, if the compressed video stream is encrypted, the main CPU 51 inputs an EMM or an ECM to the secure area 100. If the EMM or the ECM is input, the secure area 100 decrypts the scramble key Ks and outputs the scramble key Ks to the main CPU 51.

The main CPU 51 sets the scramble key Ks in the encryption circuit that is included in the decompression processing circuit 57, whereas the encryption circuit decrypts the compressed video stream by using the scramble key Ks. The decompression processing circuit 57 performs a process of decompressing the compressed video stream that has been decrypted.

In the following, the configuration of the secure area 100 will be described. As illustrated in FIG. 1, the secure area 100 includes a CPU 110, a Boot ROM 120, a RAM 130, a memory 140, a conversion circuit group 150, an encryption circuit group 160, and a secret input path IF 170.

The CPU 110 is a device that performs overall control of the secure area 100. For example, the CPU 110 performs the management program and performs overall control of the secure area 100 in accordance with the flow of the process of the management program. The Boot ROM 120 stores therein information on the initial instruction that is read when the CPU 110 is started up. The RAM 130 becomes a work area used when the CPU 110 performs various kinds of programs.

The memory 140 is a nonvolatile memory with a small capacity. The memory 140 stores therein a secret value “xxx” and a plurality of identifiers. The storage capacity of the memory 140 may also be the capacity capable of storing about the related secret value and a plurality of identifiers. The secret value and the identifiers are stored in the memory 140 when the secure area 100 is initialized. By using a pair of the secret value and the identifiers, it is possible to identify the system LSI 50a, the secure area 100, and the maker of the receiving terminal.

For example, it is assumed that, in the memory 140, the secret value of “xxx” and identifiers of “www”, “yyy”, and “bbb” are stored. The pair of the secret value “xxx” and the identifier “www” becomes the information used to uniquely identify the system LSI 50a. The pair of the secret value “xxx” and the identifier “yyy” becomes the information used to uniquely identify the secure area 100. The pair of the secret value “xxx” and the identifier “bbb” becomes the information used to uniquely identify the maker of the receiving terminal. Here, as an example, three types of identifiers are indicated; however, another identifier may also be present.

The secret value stored in the memory 140 is information that is never allowed to be taken out to the public. In contrast, if the CPU 110 accepts a request from the main CPU 51 to disclose the identifier, the CPU 110 may also disclose the identifier to the main CPU 51. Furthermore, if the secret value and the identifier of the memory 140 leak, it is possible to specify the source of leakage based on the pair of the secret value and the identifier.

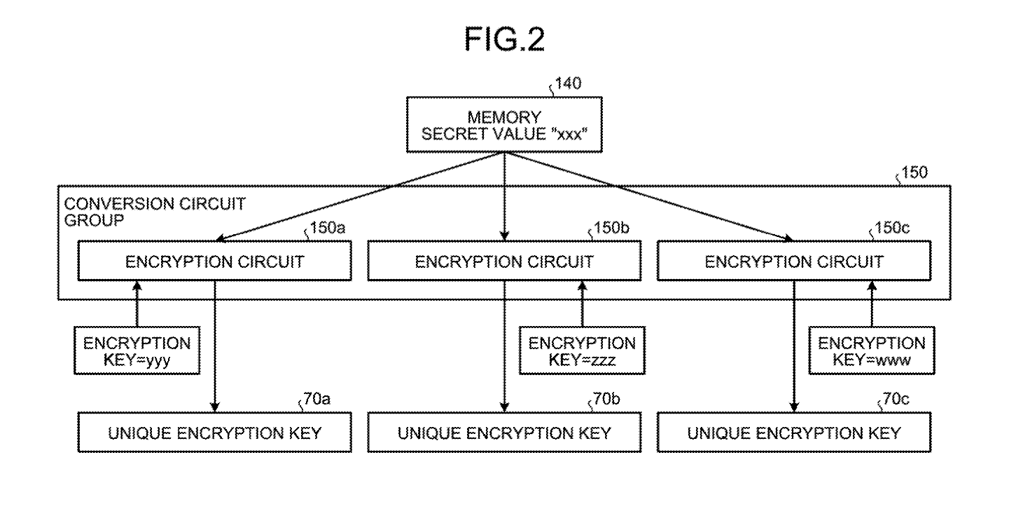

The conversion circuit group 150 is a circuit group that creates a unique encryption key based on the secret value stored in the memory 140. FIG. 2 is a schematic diagram illustrating a process performed by a conversion circuit group. In the example illustrated in FIG. 2, the conversion circuit group 150 includes encryption circuits 150a, 150b, and 150c. If a unique encryption key is created, the CPU 110 inputs the secret value “xxx” stored in the memory 140 to the encryption circuits 150a, 150b, and 150c. Furthermore, the CPU 110 inputs the encryption key “yyy” to the encryption circuit 150a, inputs the encryption key “zzz” to the encryption circuit 150b, and inputs the encryption key “www” to the encryption circuit 150c. Here, the encryption keys “yyy”, “zzz”, and “www” are information that is previously set in the secure area 100. The encryption keys “of yyy”, “zzz”, and “www” do not need to be unique information for each area in the secure area 100.

If the encryption circuit 150a receives an input of the secret value “xxx” and the encryption key “yyy”, the encryption circuit 150a outputs a unique encryption key 70a based on the secret value “xxx” and the encryption key “yyy”. If the encryption circuit 150b receives an input of the secret value “xxx” and the encryption key “zzz”, the encryption circuit 150b outputs a unique encryption key 70b based on the secret value “xxx” and the encryption key “zzz”. If the encryption circuit 150c receives an input of the secret value “xxx” and the encryption key “www”, the encryption circuit 150c outputs a unique encryption key 70c based on the secret value “xxx” and the encryption key “www”.

The encryption circuit group 160 is a circuit group that encrypts and decrypts various kinds of information. The processes of encryption and decryption performed by the encryption circuit group 160 will be described later.

The secret input path IF 170 is an interface that allows, if the secret input path IF 170 accepts a secret input signal that is previously decided by an administrator or the like, an input of the information received via the secret input path IF 170. For example, at the time of initial setting, the secret value, the identifier, the master key Ks, and various kinds of programs described above are input via the secret input path IF 170.

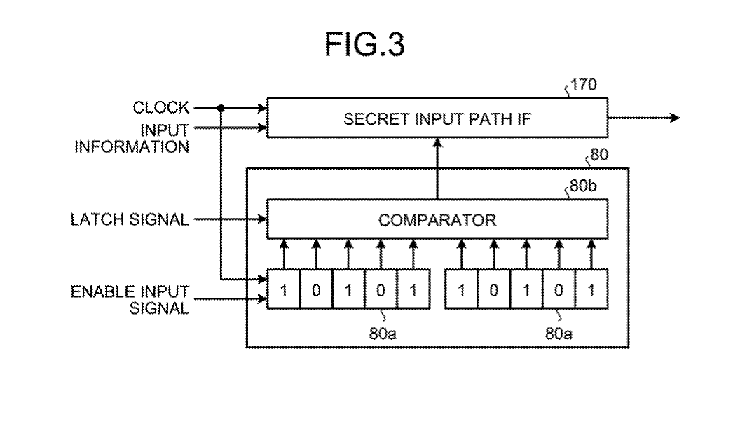

The secret input path IF 170 determines, by using an enable circuit, whether an input of the information is allowed. FIG. 3 is a schematic diagram illustrating an example of an enable circuit. As illustrated in FIG. 3, an enable circuit 80 includes primary storage units 80a and a comparator 80b. The primary storage units 80a are devices each of which temporarily stores therein an enable input signal in synchronization with the clock. The comparator 80b fetches, based on a latch signal, the enable input signal stored in the primary storage unit 80a and outputs, if the fetched enable input signal matches a previously set signal, the enable signal to the secret input path IF 170. If the secret input path IF 170 accepts the enable signal from the enable circuit 80, the secret input path IF 170 allows an input of input information received from outside.

A description will be given of a process performed at the time of initial setting of the secure area 100. The CPU 110 accepts the input information from the secret input path IF 170. In the input information, first input information that is stored in the memory 140 and second input information that is stored in the NVRAM 60 that is outside the secure area 100 are included. The first input information and the second input information are encrypted.

For example, in the first input information, the secret value and the plurality of the identifiers described above are included. If the CPU 110 accepts the encrypted first input information, the CPU 110 inputs encryption key “sss” that is set in the secure area 100 and the encrypted first input information to the encryption circuit group 160 and then decrypts the first input information.

The CPU 110 determines, based on a write inhibit flag with respect to the memory 140, whether the decrypted first input information is to be stored in the memory 140. This write inhibit flag is stored in a memory that is not illustrated. If the write inhibit flag is “OFF”, the CPU 110 stores the first input information in the memory 140 and sets the write inhibit flag to “ON”. In contrast, if the write inhibit flag is “ON”, the CPU 110 prevents the process of storing the first input information in the memory 140.

For example, in the second input information, the management program, the B-CAS program, the master key Km, an IF program, a DRM program, related confidential information, and the like are included. Furthermore, the second input information may also include a plurality of the work keys Kw. If the CPU 110 accepts the encrypted second input information, the CPU 110 inputs the encryption key “sss” that is set in the secure area 100 and the encrypted second input information to the encryption circuit group 160 and then decrypts the second input information.

Furthermore, the CPU 110 inputs both the decrypted second input information and the unique encryption key that is created by the conversion circuit group 150 to the encryption circuit group 160 and then encrypts the second input information. When the CPU 110 encrypts the second input information, the CPU 110 may also encrypt the second input information by a common unique encryption key or may also encrypt the second input information by using a plurality of unique encryption keys. In a description below, the second input information encrypted by the unique encryption key is referred to as “unique encryption information”.

By loading the IF program in the RAM 130 and executing the IF program, the CPU 110 performs the process described below. The CPU 110 outputs the unique encryption information to the main CPU 51 via the IF 52a and requests the main CPU 51 to store the unique encryption information in the NVRAM 60. If the main CPU 51 acquires the unique encryption information from the secure area 100, the main CPU 51 stores the unique encryption information in the NVRAM 60.

When the CPU 110 encrypts the second input information, the CPU 110 may also calculate a hash value of the second input information and add the calculated hash value to the unique encryption information. By adding the hash value to the unique encryption information, it is possible to detect whether the unique encryption information stored in the NVRAM 60 is altered.

For example, if the CPU 110 requests the main CPU 51 to read the unique encryption information stored in the NVRAM 60 and acquires the unique encryption information, the CPU 110 extracts the second input information by inputting the unique encryption key and the unique encryption information to the encryption circuit group 160. The CPU 110 determines whether alteration has been performed by determining whether the hash value calculated from the second input information matches the hash value that is added to the unique encryption information.

Furthermore, the CPU 110 may also perform a process aiming to confirm whether the unique encryption information has correctly been written to the NVRAM 60. Immediately after the CPU 110 requests the main CPU 51 to store the unique encryption information, the CPU 110 requests the main CPU 51 to read the unique encryption information that is stored in the NVRAM 60. For example, the CPU 110 temporarily leaves the unique encryption information in the RAM 130, compares the unique encryption information stored in the RAM 130 with the unique encryption information that has been read from the NVRAM 60, and determines whether the unique encryption information is correctly written.

If the unique encryption information is not correctly written to the NVRAM 60, the CPU 110 again requests the main CPU 51 to output the unique encryption information to the main CPU 51 and store the unique encryption information in the NVRAM 60.

A description of a process performed when, after the completion of the initial setting described above, the secure area 100 has been started up due to an instruction from the main CPU 51. If the CPU 110 receives a start instruction from the main CPU 51, the CPU 110 performs the process described below by performing the initial instruction stored in a Boot ROM 120.

The CPU 110 reads both the secret value “xxx” stored in the memory 140 and the encryption key, inputs the read the secret value and the encryption key to the conversion circuit group 150, and creates a unique encryption key. The process of creating the unique encryption key corresponds to the process described with reference to FIG. 2.

The CPU 110 requests the main CPU 51 to read the unique encryption information from the NVRAM 60. If the CPU 110 acquires the unique encryption information, the CPU 110 inputs both the unique encryption information and the unique encryption key to the encryption circuit group 160, decrypts the unique encryption information, and extracts the second input information. The CPU 110 stores the second input information in the RAM 130 such that the B-CAS program, the IF program, the DRM program, and the like can be executed. For example, the B-CAS program is a program that executes the EMM process and the ECM process. The IF program is a program that executes a process of sending and receiving information to and from the external main CPU 51 via the IF 52a. The DRM program is a program that limits and controls a process performed by using digital data in order to protect the copyright of the content that is represented by various kinds of digital data.

When the CPU 110 acquires a packet from the IF 52a, the CPU 110 identifies the packet. If the packet is an EMM, the CPU 110 performs the EMM process described below. The CPU 110 decrypts the work key Kw and the identification number by extracting the master key Km from the RAM 130, setting the master key Km in the encryption circuit group 160, and inputting the EMM to the encryption circuit group 160. The CPU 110 associates the decrypted work key Kw with the identification number and stores the associated information in the RAM 130.

If the packet is an ECM, the CPU 110 performs the ECM process described below. In the ECM, the encrypted scramble key Ks and the reference number of the work key Kw are included. The CPU 110 extracts the work key Kw associated with the reference number of the ECM from the RAM 130. The CPU 110 decrypts the scramble key Ks, by setting the extracted work key Kw in the encryption circuit group 160 and inputting ECM to the encryption circuit group 160.

After the CPU 110 decrypts the scramble key Ks, the CPU 110 outputs the information on the scramble key Ks to the main CPU 51 via the IF 52a.

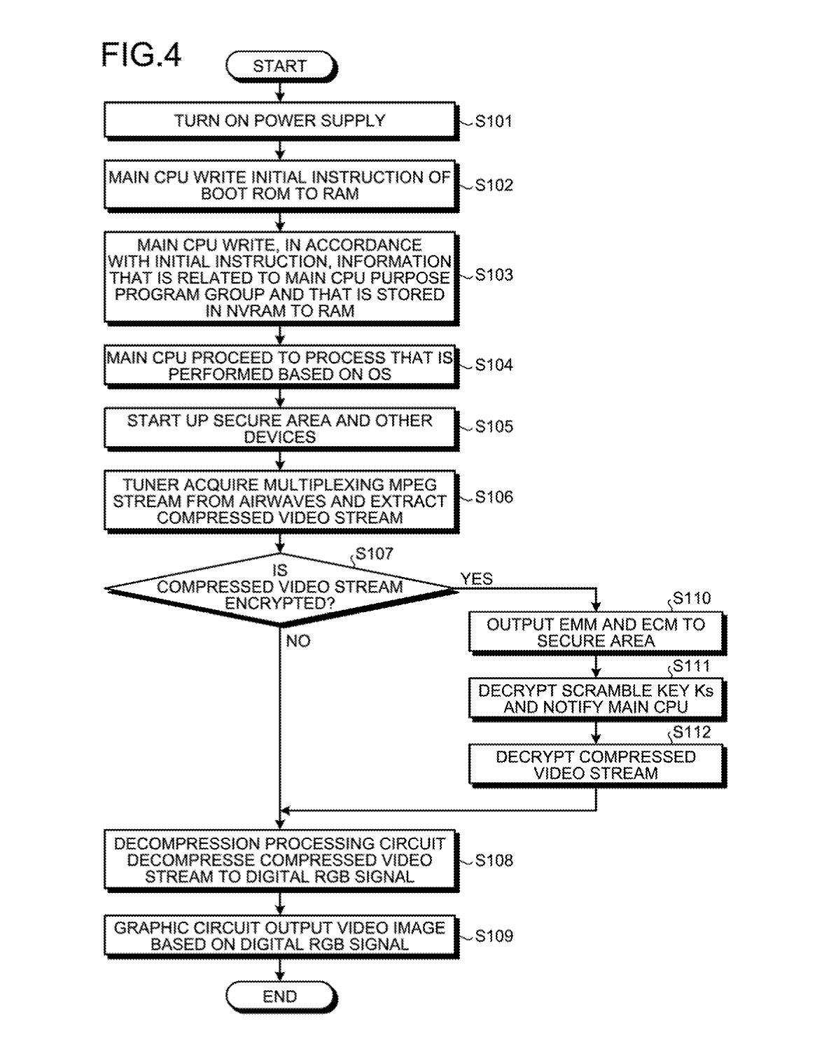

In the following, an example of the flow of a process performed in the system LSI 50a according to the first embodiment will be described. FIG. 4 is a flowchart illustrating the flow of a process performed in the system LSI according to the first embodiment. As described in FIG. 4, if a power supply of the system LSI 50a is turned on (Step S101), the main CPU 51 writes the initial instruction of the Boot ROM 53 to the RAM 54 (Step S102).

The main CPU 51 writes, in accordance with the initial instruction, the information on the main CPU purpose program group stored in the NVRAM 60 to the RAM 54 (Step S103). The main CPU 51 proceeds to the process that is performed based on the OS (Step S104).

The main CPU 51 starts up the secure area 100 and the other devices (Step S105). The Tuner 56 acquires the multiplexing MPEG stream from the airwaves and extracts the compressed video stream (Step S106). The main CPU 51 determines whether the compressed video stream is encrypted (Step S107). If the compressed video stream is not encrypted (No at Step S107), the decompression processing circuit 57 decompresses the compressed video stream to the digital RGB signal (Step S108). The graphic circuit 58 outputs the video image based on the digital RGB signal (Step S109).

A description will be given here by referring back to Step S107. If the compressed video stream is encrypted (Yes at Step S107), the main CPU 51 outputs the EMM and the ECM to the secure area (Step S110). The CPU 110 in the secure area 100 decrypts the scramble key Ks and notifies the main CPU 51 of the scramble key Ks (Step S111). The main CPU 51 sets the scramble key Ks and the compressed video stream in the encryption circuit included in the decompression processing circuit 57, decrypts the compressed video stream (Step S112), and proceeds to Step S108.

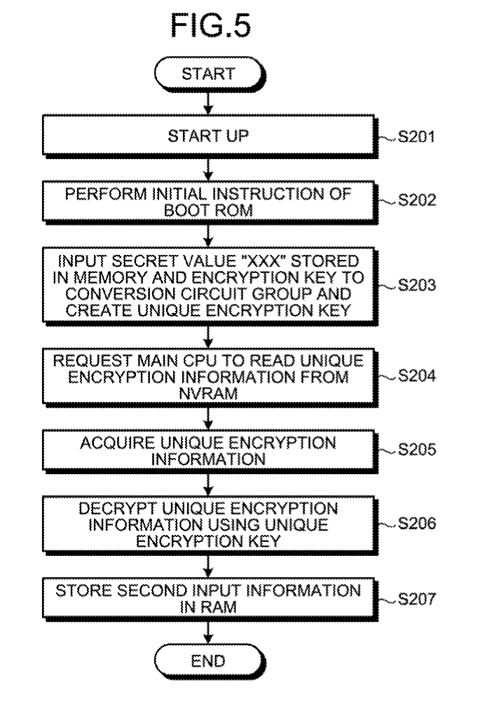

In the following, a description will be given of the flow of a process performed in the secure area 100 when the secure area 100 is started up indicated by Step S105 illustrated in FIG. 4. FIG. 5 is a flowchart illustrating the flow of a process performed in a secure area according to the first embodiment. As illustrated in FIG. 5, when the secure area 100 is started up (Step S201), the CPU 110 performs the initial instruction of the Boot ROM 120 (Step S202).

The CPU 110 inputs the secret value “xxx” stored in the memory 140 and the encryption key to the conversion circuit group 150 and creates the unique encryption key (Step S203). The CPU 110 requests the main CPU 51 to read the unique encryption information from the NVRAM 60 (Step S204).

The CPU 110 acquires the unique encryption information from outside via the IF 52a (Step S205). By decrypting the unique encryption information using the unique encryption key, the CPU 110 extracts the second input information (Step S206). The CPU 110 stores the second input information in the RAM 130 (Step S207).

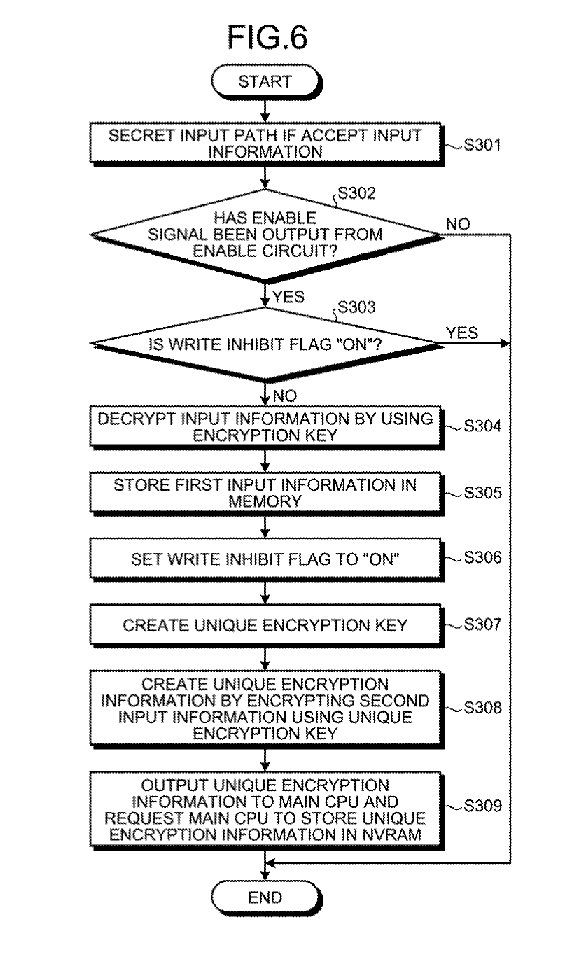

In the following, an example of the initialization process performed in the secure area according to the first embodiment will be described. This initialization process is performed before the processes illustrated in FIGS. 4 and 5. FIG. 6 is a flowchart illustrating the flow of an initialization process performed in the secure area according to the first embodiment. As illustrated in FIG. 6, the secret input path IF 170 in the secure area 100 accepts the input information (Step S301) and determines whether the enable signal has been output from the enable circuit (Step S302).

If the enable signal is not output from the enable circuit (No at Step S302), the secure area 100 ends the process. In contrast, if the enable signal has been output from the enable circuit (Yes at Step S302), the CPU 110 determines whether the write inhibit flag is “ON” (Step S303).

If the write inhibit flag is “ON” (Yes at Step S303), the CPU 110 ends the process. In contrast, if the write inhibit flag is not “ON” (No at Step S303), the CPU 110 decrypts the input information by using the encryption key “sss” (Step S304). For example, in the input information, the first input information and the second input information are included.

The CPU 110 stores the first input information in the memory 140 (Step S305) and sets the write inhibit flag to “ON” (Step S306). By inputting the secret value “xxx” and the encryption key included in the first input information to the conversion circuit group 150, the CPU 110 creates the unique encryption key (Step S307).

By encrypting the second input information using the unique encryption key, the CPU 110 creates the unique encryption information (Step S308). The CPU 110 outputs the unique encryption information to the main CPU 51 and requests the main CPU 51 to store the unique encryption information in the NVRAM 60 (Step S309).

In the following, a description will be given of an example of various kinds of initial setting processes performed in the secure area according to the first embodiment. First, a description will be given of a process of the initial setting performed in the secure area 100 in the shipment stage in a receiving apparatus factory. As an example, it is assumed that a “management organization” is present and the management organization manages information that is to be written to the secure area 100. Confidential information that is used for the secure area 100 arrives, in an encrypted state, at the receiving apparatus factory from the management organization. In the confidential information, the first input information and the second input information described above are included. Furthermore, the secret value and the identifier included in the first input information do not need to be paired; however, in such a case, it is difficult to identify the secret value.

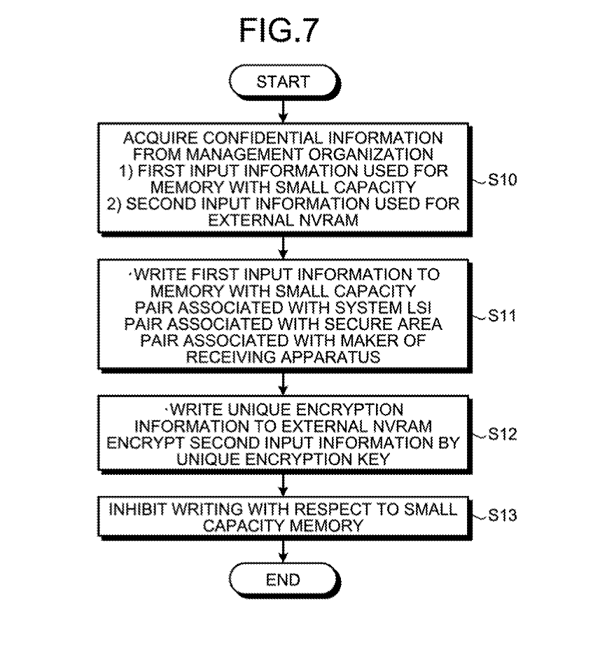

FIG. 7 is a flowchart (1) illustrating an example of a process that performs initialization. A worker of the receiving apparatus factory acquires the confidential information from the management organization (Step S10). For example, the confidential information is encrypted and the first input information used for the memory 140 with small capacity and the second input information used for the external NVRAM 60 are included.

The worker of the receiving apparatus factory writes the first input information to the memory 140 with small capacity via the secret input path IF 170 (Step S11). For example, in the first input information, a pair of the secret value and the identifier associated with the system LSI, a pair of the secret value and the identifier associated with the secure area 100, and a pair of the secret value and the identifier associated with the maker of the receiving apparatus are included.

The worker of the receiving apparatus factory writes the unique encryption information to the external NVRAM 60 via the secret input path IF 170 (Step S12). As described in the initialization process illustrated in FIG. 6, the second input information that has been input via the secret input path IF 170 is encrypted by the unique encryption key, becomes the unique encryption information, and is written to the NVRAM 60.

For example, the secure related information from among the pieces of the second input information is encrypted by using the unique encryption key that is created from the pair of the secret value and the identifier associated with the secure area 100. The system LSI related information from among the pieces of the second input information is encrypted by using the unique encryption key that is created from the pair of the secret value and the identifier associated with the system LSI. The receiving apparatus related information from among the pieces of the second input information is encrypted by using the unique encryption key that is created from the pair of the secret value and the identifier associated with the receiving apparatus.

Here, after having written the first input information to the memory 140 with small capacity and after having written the unique encryption information to the external NVRAM 60, the worker in the receiving apparatus factory may also perform an operation test of the receiving apparatus. In the last stage of the factory shipment, the worker in the receiving apparatus factory sets the write inhibit flag to ON (Step S13).

In the following, a description will be given of a process in which both the LSI factory and the receiving apparatus factory perform initial setting in a shared manner. For example, the confidential information arrives, in an encrypted state, at the LSI factory and the receiving apparatus factory from the management organization. For example, the first input information is included in the confidential information delivered from the LSI factory. The second input information is included in the confidential information delivered from the receiving apparatus factory.

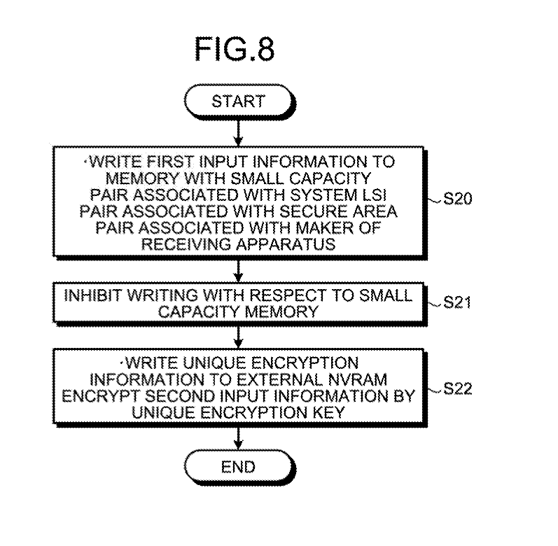

FIG. 8 is a flowchart (2) illustrating an example of a process that performs initialization. For example, in FIG. 8, the processes at Steps S20 and S21 are performed in the LSI factory. The process at Step S22 is performed in the receiving apparatus factory. The worker in the LSI factory and the worker in the receiving apparatus factory acquire the confidential information from the management organization.

The worker of the LSI factory writes the first input information to the memory 140 with small capacity via the secret input path IF 170 (Step S20). For example, in the first input information, the pair of the secret value and the identifier associated with the system LSI, the pair of the secret value and the identifier associated with the secure area 100, and the pair of the secret value and the identifier associated with the maker of the receiving apparatus are included.

After having written the first input information to the memory 140 with small capacity, the worker of the LSI factory sets the write inhibit flag with respect to the memory 140 with small capacity to ON (Step S21).

The worker of the receiving apparatus factory writes the unique encryption information to the external NVRAM 60 via the secret input path IF 170 (Step S22). As described in the initialization process illustrated in FIG. 6, the second input information that is input via the secret input path IF 170 is encrypted by the unique encryption key, becomes the unique encryption information, and is written to the NVRAM 60.

In the following, the effect of the secure area 100 according to the first embodiment will be described. In the secure area 100, the CPU 110 running in the secure area 100 acquires, in an encrypted state from the secret input path IF 170, the first input information that includes the secret value and the second input information that includes various kinds of programs, a master key, and the like. The CPU 110 decrypts the first input information and the second input information and stores the first input information in the memory 140. The CPU 110 creates a unique encryption key based on the first input information, encrypts the second input information by the unique encryption key, and requests the external main CPU 51 to store the encrypted second input information in the external NVRAM 60. Consequently, even if the storage capacity of the memory 140 in the secure area is small, it is possible to package the plurality of the programs by using the external NVRAM 60.

Furthermore, because the external NVRAM 60 is encrypted by the unique encryption key created from the secret value “xxx” in the secure area, it is possible to prevent leakage of the unique encryption information.

Incidentally, the memory 140 that stores therein the first input information and the memory that stores therein the write inhibit flag may also be a one-time Rom (OTR) that does not allow information that is written once to be updated. Furthermore, the memory 140 may also be used as the OTR and the memory that stores therein the write inhibit flag may also be used as the NVRAM. Furthermore, the memory 140 may also be used as the NVRAM and the memory that stores therein the write inhibit flag may also be used as the OTR. Furthermore, the memory 140 and the memory that stores therein the write inhibit flag may also be used as the NVRAM. Furthermore, it may also possible to arrange an area used to set the write inhibit flag in a part of area in the memory 140.

Furthermore, in the first embodiment described above, the memory 140 is an example of a first memory. The NVRAM 60 is an example of a second memory. The memory that stores therein the write inhibit flag is an example of a third memory. The drawing of the memory that stores therein the write inhibit flag is omitted.

### [b] Second Embodiment

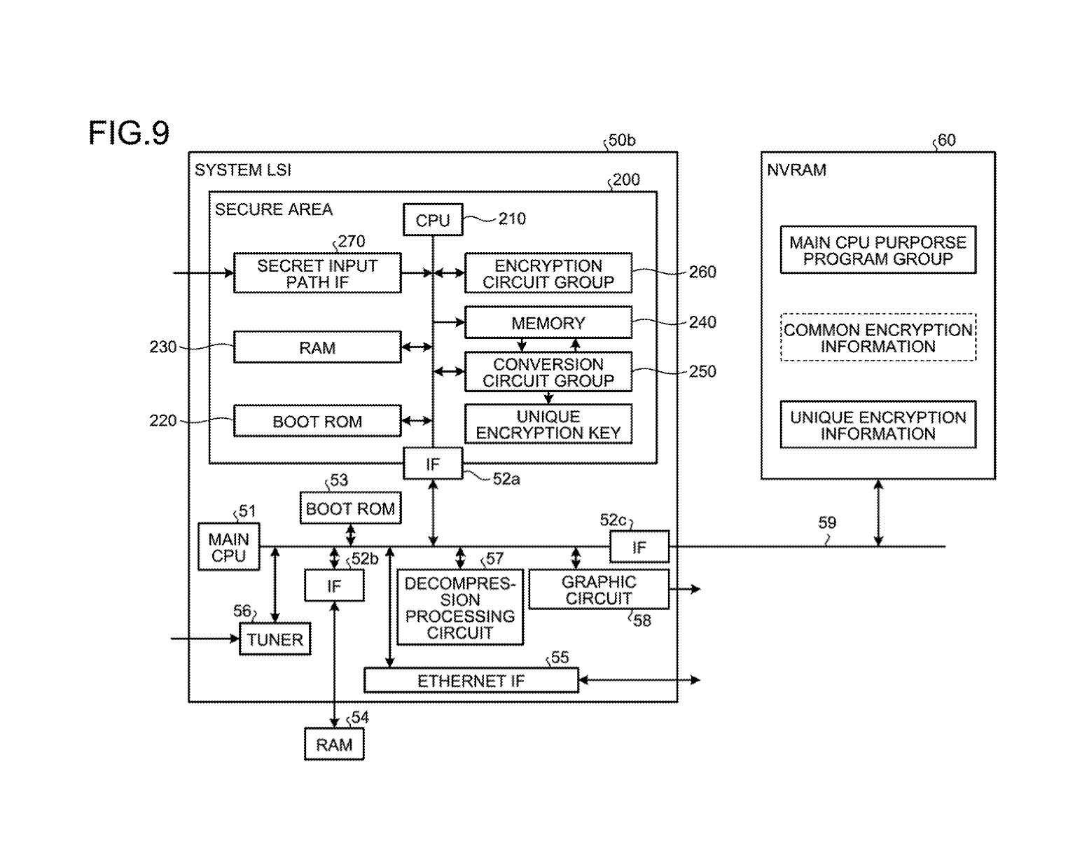

The configuration of a system LSI according to a second embodiment will be described. FIG. 9 is a schematic diagram illustrating an example of a system LSI according to a second embodiment. As illustrated in FIG. 9, a system LSI 50b includes the main CPU 51, the IFs 52a, 52b, and 52c, the Boot ROM 53, the RAM 54, the Ethernet IF 55, the Tuner 56, the decompression processing circuit 57, the graphic circuit 58, and a secure area 200. The system LSI 50b is connected to the NVRAM 60.

Regarding the devices described above, descriptions of the main CPU 51, the IFs 52a, 52b, and 52c, the Boot ROM 53, the RAM 54, the Ethernet IF 55, the Tuner 56, the decompression processing circuit 57, and the graphic circuit 58 are the same as those described in the first embodiment.

The NVRAM 60 includes the main CPU purpose program group and the common encryption information. The common encryption information is the second input information encrypted by a common key that is common to each area in the secure area. A description of the second input information is the same as that described in the first embodiment. After having been input to the secure area 200 and decrypted, the common encryption information is encrypted by the unique encryption key in the secure area 200 and stored in the NVRAM 60 as the unique encryption information. For example, the common encryption information is deleted from the NVRAM 60 after the common encryption information is input to the secure area 200.

The configuration of the secure area 200 will be described. As illustrated in FIG. 9, the secure area 200 includes a CPU 210, a Boot ROM 220, a RAM 230, a memory 240, a conversion circuit group 250, an encryption circuit group 260, and a secret input path IF 270.

The CPU 210 is a device that performs overall control of the secure area 200. The Boot ROM 220 stores therein the information on the initial instruction that is read when the CPU 210 is started up. The RAM 230 becomes a work area that is used when the CPU 210 executes various kinds of programs.

The memory 240 is a nonvolatile small capacity memory. The memory 240 stores therein the secret value “xxx” and a plurality of identifiers. The storage capacity of the memory 240 may also be the capacity capable of storing about the related secret value and a plurality of identifiers. The secret value and the identifiers are stored in the memory 240 when the secure area 200 is initialized. Similarly to the secure area 100 according to the first embodiment, the process of storing the secret value and the identifiers in the memory 240 is performed via the secret input path IF 270.

The conversion circuit group 250 is a circuit group that creates a unique encryption key based on the secret value stored in the memory 240. A description related to the conversion circuit group 250 is the same as that related to the conversion circuit group 150 in the first embodiment.

The encryption circuit group 260 is a circuit group that encrypts and decrypts various kinds of information. The processes of encryption and decryption performed by the encryption circuit group 260 are the same as those performed by the encryption circuit group 160 described in the first embodiment.

The secret input path IF 270 is an interface that allows, if the secret input path IF 270 accepts a secret input signal that has previously been decided by an administrator or the like, an input of the information received via the secret input path IF 270. The description related to the secret input path IF 270 is the same as that related to the secret input path IF 170 in the first embodiment. The secure area 200 according to the second embodiment acquires the encrypted first input information via the secret input path IF 270. Furthermore, the secure area 200 acquires the second input information from the IF 52a as the common encryption information.

A description will be given of a process performed at the time of initial setting of the secure area 200. The CPU 210 accepts the first input information from the secret input path IF 270. The first input information has been encrypted.

For example, in the first input information, the secret value and the plurality of identifiers are included. If the CPU 210 accepts the encrypted first input information, the CPU 210 inputs encryption key “sss” that is set in the secure area 200 and the encrypted first input information to the encryption circuit group 260 and decrypts the first input information.

The CPU 210 determines, based on the write inhibit flag associated with the memory 240, whether the decrypted first input information is to be stored in the memory 240. The write inhibit flag is stored in a memory that is not illustrated. If the write inhibit flag is “OFF”, the CPU 210 stores the first input information in the memory 240 and sets the write inhibit flag to “ON”. In contrast, if the write inhibit flag is “ON”, the CPU 210 prevents the process of storing the first input information in the memory 240.

If the CPU 210 accepts an initialize instruction from the main CPU 51, the CPU 210 requests the main CPU 51 to receive common encryption information stored in the NVRAM 60. In response to the request from the CPU 210, the main CPU 51 reads the common encryption information from the NVRAM 60 and inputs the information to the secure area 200. Furthermore, after having input the common encryption information to the secure area 200, the main CPU 51 deletes the common encryption information from the NVRAM 60.

If the CPU 210 acquires the common encryption information from the main CPU 51, the CPU 210 inputs both the common key that is set in the secure area 200 and the common encryption information to the encryption circuit group 260, decrypts the common encryption information, and extracts the second input information.

The CPU 210 inputs the decrypted second input information and the unique encryption key that is created by the conversion circuit group 250 to the encryption circuit group 260 and then encrypts the second input information. When the CPU 210 encrypts the second input information, the CPU 210 may also encrypt the second input information by a common unique encryption key or by using a plurality of unique encryption keys. Hereinafter, the second input information encrypted by using the unique encryption key is referred to as unique encryption information.

The CPU 210 performs the process described below by loading and executing the IF program in the RAM 230. The CPU 210 outputs the unique encryption information to the main CPU 51 via the IF 52a and requests the main CPU 51 to store the unique encryption information in the NVRAM 60. If the main CPU 51 acquires the unique encryption information from the secure area 200, the main CPU 51 stores the unique encryption information in the NVRAM 60.

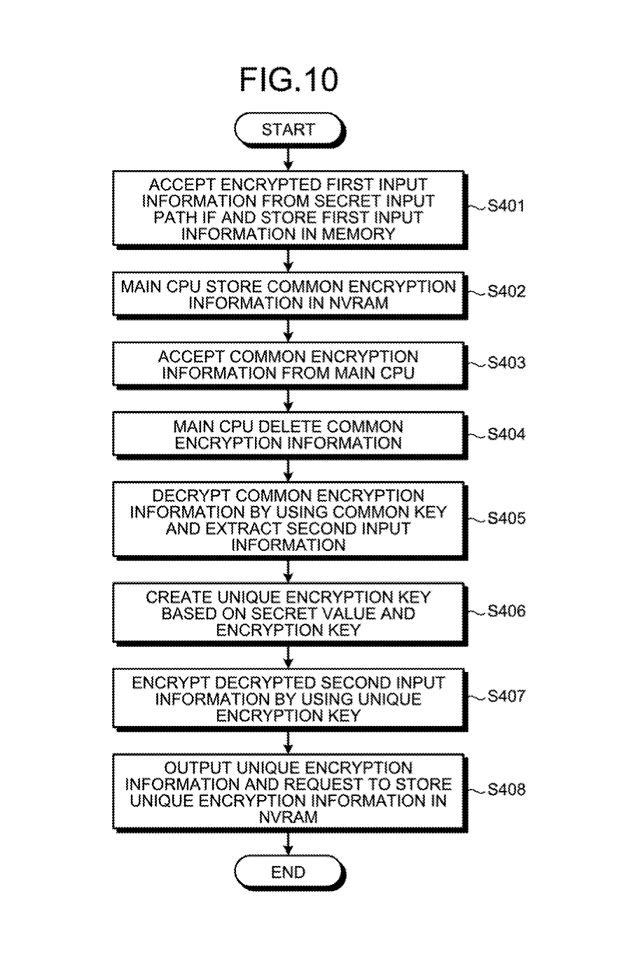

In the following, an example of the initialization process performed in the secure area according to the second embodiment will be described. FIG. 10 is a flowchart illustrating the flow of the initialization process performed in the secure area according to the second embodiment. As illustrated in FIG. 10, the CPU 210 in the secure area 200 accepts the encrypted first input information from the secret input path IF 270 and stores the first input information in the memory 240 (Step S401). The process indicated at Step S401 is the same as the processes performed at Steps S301 to S305 illustrated in FIG. 6 described in the first embodiment.

The main CPU 51 stores the common encryption information in the NVRAM 60 (Step S402). The CPU 210 accepts the common encryption information from the main CPU 51 (Step S403). The main CPU 51 deletes the common encryption information from the NVRAM 60 (Step S404).

The CPU 210 decrypts the common encryption information by using the common key in the secure area 200 and extracts the second input information (Step S405). By inputting the secret value “xxx” and the encryption key that are included in the first information to the conversion circuit group 250, the CPU 210 creates the unique encryption key (Step S406).

By encrypting the second input information by using the unique encryption key, the CPU 210 creates the unique encryption information (Step S407). The CPU 210 outputs the unique encryption information to the main CPU 51 and requests the main CPU 51 to store the unique encryption information in the NVRAM 60 (Step S408).

In the following, a description will be given of an example of various kinds of processes of initial setting in the secure area according to the second embodiment. First, a description will be given of a process of the initial setting performed, in a shared manner, by an LSI factory, a receiving apparatus factory, and a viewer's house. For example, confidential information is delivered in an encrypted state to the LSI factory and the receiving apparatus factory from the management organization. For example, the first input information is included in the confidential information that is delivered to the LSI factory. The second input information is included in the confidential information that is delivered to the receiving apparatus factory.

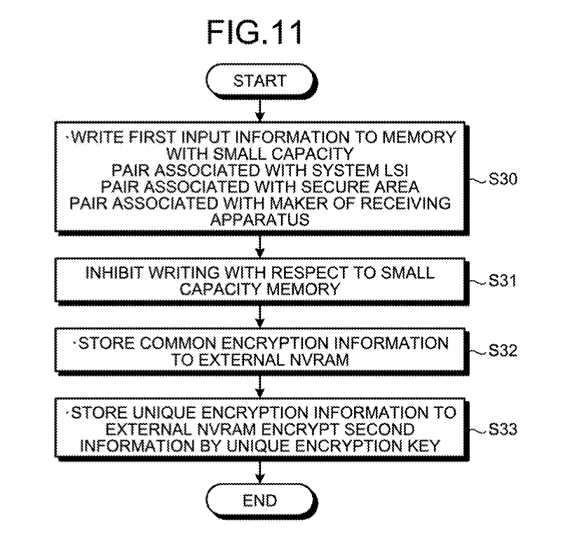

FIG. 11 is a flowchart (3) illustrating an example of a process that performs initialization. For example, in FIG. 11, the processes at Steps S30 and S31 are performed in the LSI factory. The process at Step S32 is performed in the receiving apparatus factory. The process at Step S33 is performs at the time of purchase of the receiving apparatus in the viewer's house.

A worker of the LSI factory writes, via the secret input path IF 270, the first input information to the memory 240 with small capacity (Step S30). For example, in the first input information, a pair of the secret value and the identifier associated with the system LSI, a pair of the secret value and the identifier associated with the secure area 200, and a pair of the secret value and the identifier associated with the maker of the receiving apparatus are included. Furthermore, after having stored the first input information in the memory 240, the CPU 210 in the secure area 200 may also create the master key Km and the viewer identification number by using the pair of the secret value and the identifier. Furthermore, if a plurality of the CAS techniques is present, the CPU 210 may also create the master key Km and the viewer identification number for each of the CAS techniques by using the pair of the secret value and the identifier.

After having written the first input information to the small capacity memory 240, the worker of the LSI factory sets the write inhibit flag with respect to the small capacity memory 240 to ON (Step S31).

The worker of the receiving apparatus factory inputs the common encryption information that is obtained by encrypting the second input information by the common key to the system LSI 50b, whereas the main CPU 51 stores the common encryption information in the external NVRAM 60 (Step S32). Here, as illustrated in Step S30, if the master key Km and the viewer identification information are individually created in the secure area 200, only various kinds of programs that are commonly used in each area in the secure area 200 are included in the second input information, whereas the master key Km and the viewer identification information do not need to be included in the second input information.

If a power supply of the receiving apparatus purchased by a viewer of the viewer's house is turned on, the CPU 210 in the secure area 200 requests the main CPU 51 to acquire the common encryption information and extracts the second input information from the common encryption information by using the common key. Then, the CPU 210 encrypt the second input information by the unique encryption key and requests the main CPU 51 to store second input information in the NVRAM 60 (Step S33). Furthermore, the common encryption information stored in the NVRAM 60 is deleted by the main CPU 51.

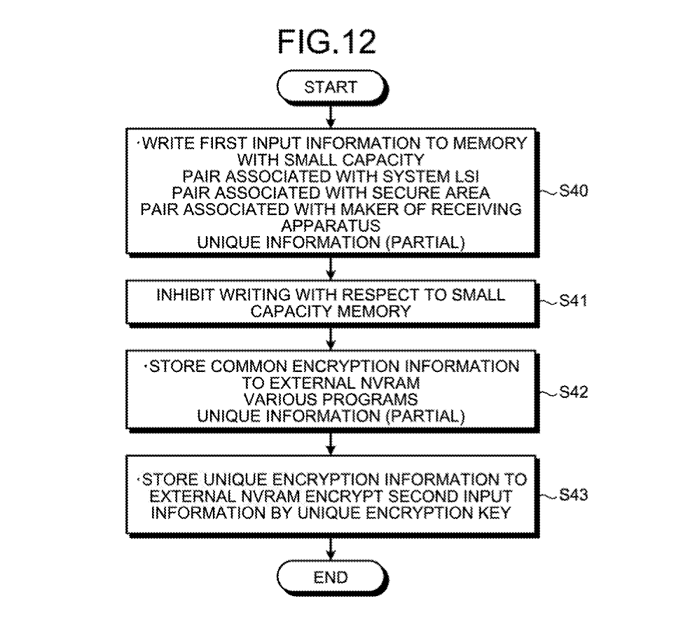

FIG. 12 is a flowchart (4) illustrating an example of a process that performs initialization. For example, in FIG. 12, the processes at Steps S40 and S41 are performed in the LSI factory. The process at Step S42 is performed in the receiving apparatus factory. The process at Step S43 is performed at the time of purchase of the receiving apparatus in the viewer's house.

The worker of the LSI factory writes the first input information to the small capacity memory 240 via the secret input path IF 270 (Step S40). For example, in the first input information, the pair of the secret value and the identifier associated with the system LSI, the pair of the secret value and the identifier associated with the secure area 200, and the pair of the secret value and the identifier associated with the maker of the receiving apparatus are included. Furthermore, a part of unique information may also be included in the first input information. For example, in the unique information, the master key Km that is used by the B-CAS program, the public key that is used by the DRM program, the secret key, and the certification are included. From among the pieces of the unique information, a part of the information is included in the first input information.

After having written the first input information to the small capacity memory 240, the worker of the LSI factory sets the write inhibit flag with respect to the small capacity memory 240 to ON (Step S41).

The worker of the receiving apparatus factory inputs the common encryption information that is obtained by encrypting the second input information by the common key to the system LSI 50b and the main CPU 51 stores the common encryption information in the NVRAM 60 (Step S42). Furthermore, in the second input information, from among the pieces of the unique information, the remaining unique information that is not included in the first input information is included.

If a power supply of the receiving apparatus purchased by the viewer in the viewer's house is turned on, the CPU 210 in the secure area 200 requests the main CPU 51 to acquire the common encryption information and extracts the second input information from the common encryption information by using the common key. Then, the CPU 210 encrypts the second input information by the unique encryption key and requests the main CPU 51 to store the second input information in the NVRAM 60 (Step S43). The common encryption information stored in the NVRAM 60 is deleted by the main CPU 51.

In the following, the effect of the secure area 200 according to the second embodiment will be described. Similarly to the secure area 100, the secure area 200 acquires the first input information and stores the first input information in the memory 240. Furthermore, the second input information is stored in the NVRAM 60 in the state in which the second input information is encrypted by the common key that is common to each of the receiving apparatuses. The secure area 200 acquires the common encryption information, decrypts the common encryption information by the common key in the secure area 200, encrypts the decrypted second input information by the unique encryption key that is created from the first input information, and requests the main CPU 51 to store the second input information in the NVRAM 60. Consequently, even if the storage capacity of the memory 240 in the secure area is small, it is possible to implement a plurality of programs by using the external NVRAM 60.

Furthermore, if the common encryption information encrypted by the common key that is common to each of the receiving apparatuses is stored in the NVRAM 60, the secure area 200 again encrypts the information by using the unique encryption key at the time of initial setting and stores the information in the NVRAM 60. Consequently, it is possible to perform, in a shared manner, the operation of storing the information in the small capacity memory 240 and the operation of storing the information in the NVRAM 60.

Furthermore, because the common encryption information stored in the NVRAM 60 is deleted when the unique encryption information is created, it is possible to prevent the common encryption information from leaking outside.

### [c] Third Embodiment

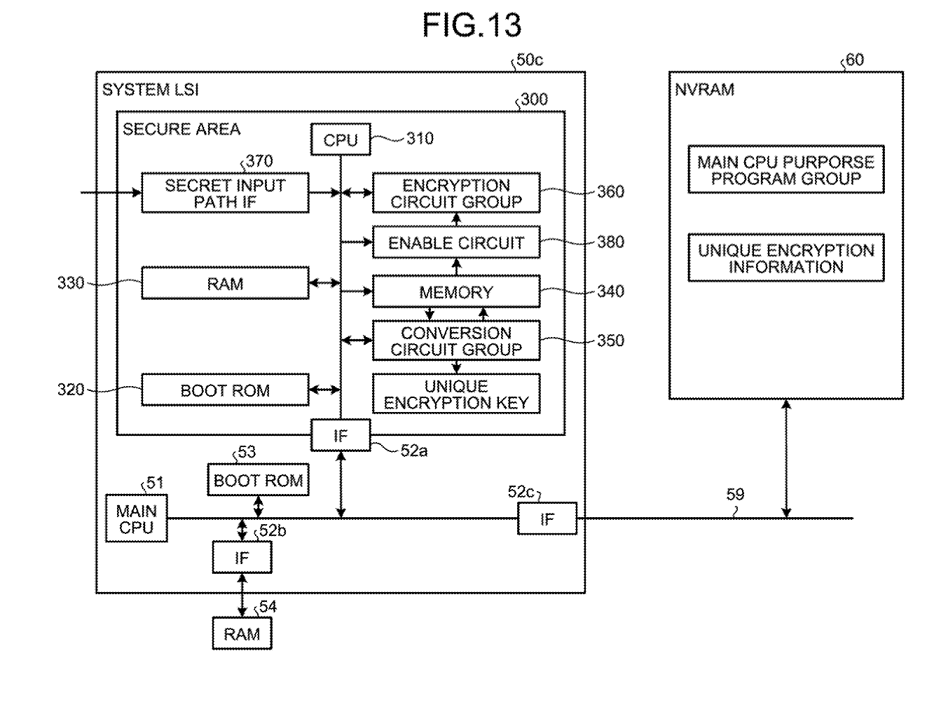

The configuration of a system LSI according to a third embodiment will be described. FIG. 13 is a schematic diagram illustrating an example of a system LSI according to a third embodiment. As illustrated in FIG. 13, a system LSI 50c includes the main CPU 51, the IFs 52a, 52b, and 52c, the Boot ROM 53, the RAM 54, and a secure area 300. In the third embodiment, the drawing of the Ethernet IF, the Tuner, the decompression processing circuit, the graphic circuit is omitted. The system LSI 50c is connected to the NVRAM 60.

Descriptions of the main CPU 51, the IFs 52a, 52b, and 52c, the Boot ROM 53, and the RAM 54 are the same as those described in the first embodiment.

The configuration of the secure area 300 will be described. As illustrated in FIG. 13, the secure area 300 includes a CPU 310, a Boot ROM 320, a RAM 330, a memory 340, a conversion circuit group 350, an encryption circuit group 360, a secret input path IF 370, and an enable circuit 380.

The CPU 310 is a device that performs overall control of the secure area 300. The Boot ROM 320 stores therein initial instruction information that is read when the CPU 310 is started up. The RAM 330 becomes a work area used when the CPU 310 executes various kinds of programs.

The memory 340 is a nonvolatile memory with small capacity. The memory 340 stores therein the secret value “xxx” and a plurality of identifiers. The storage capacity of the memory 340 may also be the capacity capable of storing about the related secret value and a plurality of identifiers. The secret value and the identifier are stored in the memory 340 when the secure area 300 is initialized. Similarly to the secure area 100 according to the first embodiment, the process of storing the secret value and the identifier in the memory 340 is performed via the secret input path IF 370.

The conversion circuit group 350 is a circuit group that creates a unique encryption key based on the secret value stored in the memory 340. A description related to the conversion circuit group 350 is the same as that related to the conversion circuit group 150 according to the first embodiment.

The encryption circuit group 360 is a circuit group that encrypts and decrypts various kinds of information. The description of the processes of encryption and decryption performed by the encryption circuit group 360 are the same as those performed by the encryption circuit group 160 according to the first embodiment. The encryption circuit group 360 is in the activated state or the inactivated state due to an instruction from the CPU 310. The encryption circuit group 360 encrypts, in a case of activated state, information that is input.

The secret input path IF 370 is an interface that allows, if the secret input path IF 370 accepts a secret input signal that is previously decided by an administrator or the like, an input of information via the secret input path IF 370. A description related to the secret input path IF 370 is the same as that related to the secret input path IF 170 described in the first embodiment.

The enable circuit 380 is a device that determines whether a unique value previously set in the CPU 310 match the value in the specified area of the program and that outputs, if both match, an enable signal. A description related to the unique value and the specified area will be described later.

A process at the time of initial setting of the secure area 300 will be described. The CPU 310 accepts the first input information and the second input information from the secret input path IF 370. The first input information and the second input information are encrypted.

For example, in the first input information, the secret value and a plurality of identifiers are included. If the CPU 310 accepts the encrypted first input information, the CPU 310 inputs both the encryption key “sss” that is set in the secure area 300 and the encrypted first input information to the encryption circuit group 360 and then decrypts the first input information.

The CPU 310 determines, based on the write inhibit flag associated with the memory 340, whether the decrypted first input information is to be stored in the memory 340. This write inhibit flag is stored in the memory that is not illustrated. If the write inhibit flag is “OFF”, the CPU 310 stores the first input information in the memory 340 and sets the write inhibit flag to “ON”. In contrast, if the write inhibit flag is “ON”, the CPU 310 prevents the process of storing the first input information in the memory 340.

Furthermore, the CPU 310 inputs the secret value of the first input information to the conversion circuit group 350 and creates a unique value. The CPU 310 sets the created unique value in the enable circuit 380.

In the second input information, the management program, the B-CAS program, the master key Km, the IF program, the DRM program, the related confidential information, and the like are included. Furthermore, the CPU 310 may also create the master key Km or the viewer identification information from a combination of the secret value and the identifier information.

When the CPU 310 accepts the encrypted second input information, the CPU 310 inputs the encryption key “sss” that is set in the secure area 300 and the encrypted second input information to the encryption circuit group 360 and decrypts the second input information.

After having decrypted the second input information, By inserting the unique value into the specified area of each of the programs, the CPU 310 updates the second input information. The specified area of each of the programs is previously decided by the management organization or the like.

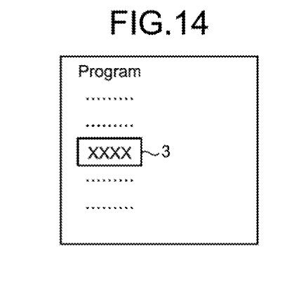

FIG. 14 is a schematic diagram illustrating a process in which the CPU inserts a unique value into an area specified by a program. For example, it is assumed that the unique value is “XXXX”. The CPU 310 inserts the unique value “XXXX” into a specified area 3 of a certain program. The CPU 310 also inserts the unique value into the specified area 3 for the other programs. Furthermore, the CPU 310 sets the unique value “XXXX” in the enable circuit 380.

The CPU 310 creates unique encryption information by inputting both the decrypted and updated second input information and the unique encryption key that is created by the conversion circuit group 350 to the encryption circuit group 360 and by encrypting the second input information. When the CPU 310 encrypts the second input information, the CPU 310 may also encrypt the second input information by the common unique encryption key or by using a plurality of the unique encryption keys.

The CPU 310 performs the process described below by loading the IF program in the RAM 330. The CPU 310 outputs the unique encryption information to the main CPU 51 via the IF 52a and requests the main CPU 51 to store the unique encryption information in the NVRAM 60. If the main CPU 51 acquires the unique encryption information from the secure area 300, the main CPU 51 stores the unique encryption information in the NVRAM 60.

A description will be given of a process performed when, after having set the initial setting described above, the secure area 300 is started up due to an instruction from the main CPU 51. If the CPU 310 receives a start instruction from the main CPU 51, the CPU 310 performs the process described below by performing the initial instruction stored in the Boot ROM 320.

The CPU 310 reads both the secret value “xxx” stored in the memory 340 and the encryption key, inputs the read data to the conversion circuit group 350, and creates a unique encryption key. The process of creating the unique encryption key corresponds to the process described with reference to FIG. 2.

The CPU 310 requests the main CPU 51 to read the unique encryption information from the NVRAM 60. If the CPU 310 acquires the unique encryption information, the CPU 310 inputs the unique encryption information and the unique encryption key to the encryption circuit group 360, decrypts the unique encryption information, and extracts the second input information.

The CPU 310 stores the second input information in the RAM 330 and inputs the management program, the B-CAS program, the IF program, the DRM program, and the like to the enable circuit 380. If, regarding each of the programs, the enable signal is output from the enable circuit 380, the CPU 310 allows the management program, the B-CAS program, the IF program, the DRM program, and the like to be executed.

For example, the management program is a program in which the procedure for the CPU 310 performing overall control of the secure area 300 is defined. The B-CAS program is a program for executing the EMM process, and the ECM process. The IF program is a program for sending and receiving information to and from the external main CPU 51 via the IF 52a. The DRM program is a program for limiting and controlling using digital data in order to protect copyright of the content represented as various kinds of digital data.

The process of reading each of the programs and performing the EMM process, the ECM process, and the like performed by the CPU 310 is the same as that performed by the CPU 110 according to the first embodiment; therefore, descriptions thereof will be omitted.

In contrast, if there is a program from which the enable signal is not output from the enable circuit 380, the CPU 310 inactivates one of the circuits in the secure area 300. For example, the CPU 310 inactivates the encryption circuit group 360. Because the program from which the enable signal may possibly be altered during the operation of storing data in the NVRAM 60, information leakage or the like is prevented beforehand so as not able to execute the program by inactivating one of the circuits in the secure area 300.

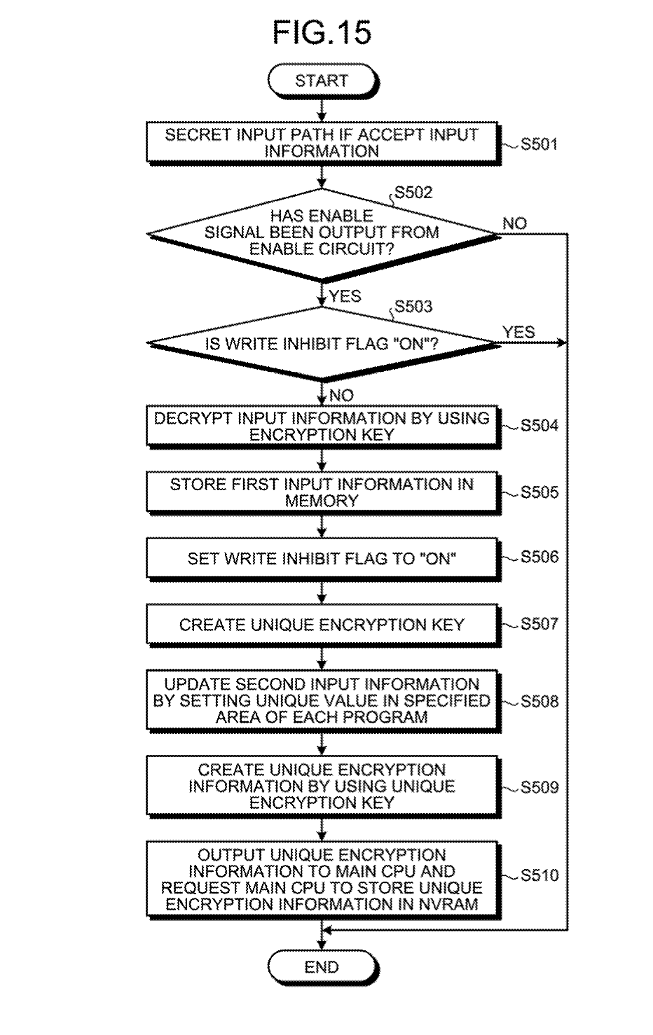

In the following, a description will be given of an example of the initialization process performed on the secure area according to the third embodiment. FIG. 15 is a flowchart illustrating the flow of an initialization process performed in the secure area according to the third embodiment. As illustrated in FIG. 15, the secret input path IF 370 in the secure area 300 accept the input information (Step S501), and determines whether an enable signal is output from the enable circuit connected to the secret input path IF 370 (Step S502).

If the enable signal is not output from the enable circuit (No at Step S502), the secure area 300 ends the process. In contrast, if the enable signal is output from the enable circuit (Yes at Step S502), the CPU 310 determines whether the write inhibit flag is “ON” (Step S503).

If the write inhibit flag is “ON” (Yes at Step S503), the CPU 310 ends the process. In contrast, if the write inhibit flag is not “ON” (No at Step S503), the CPU 310 decrypts the input information by using the encryption key “sss” (Step S504). For example, in the input information, the first input information and the second input information are included.

The CPU 310 stores the first input information in the memory 340 (Step S505) and sets the write inhibit flag to “ON” (Step S506). The CPU 110 creates a unique encryption key by inputting the secret value “xxx” and the encryption key included in the first input information to the conversion circuit group 350 (Step S507).

The CPU 310 updates the second input information by creating a unique value by converting the first input information and by setting the unique value in the specified area of each of the programs (Step S508). The CPU 310 creates the unique encryption information by encrypting the second input information by using the unique encryption key (Step S509). The CPU 310 outputs the unique encryption information to the main CPU 51 and requests the main CPU 51 to store the unique encryption information in the NVRAM 60 (Step S510).

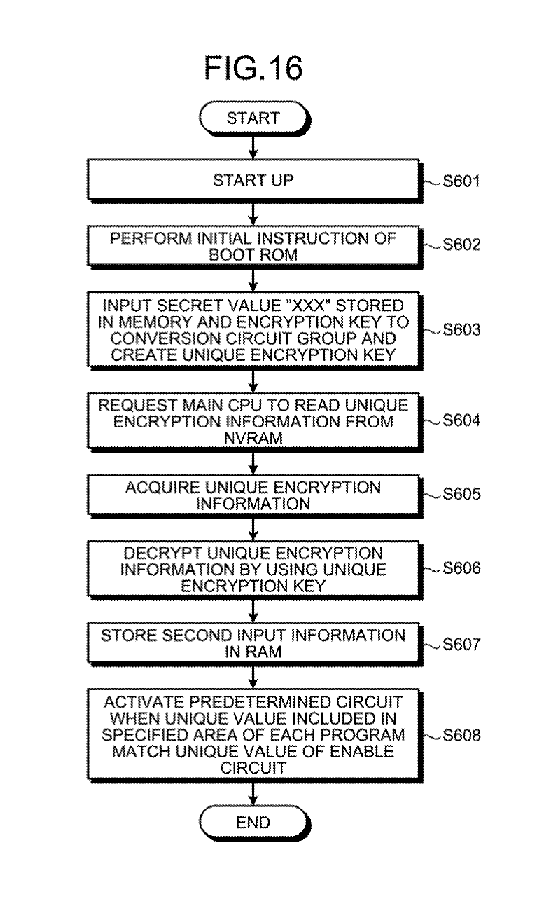

In the following, a description will be given of the flow of the process performed on the secure area 300 when the secure area 300 is started up. FIG. 16 is a flowchart illustrating the flow of a process performed in the secure area according to the third embodiment. As illustrated in FIG. 16, if the secure area 300 is started up (Step S601), the CPU 310 performs the initial instruction of the Boot ROM 320 (Step S602).

The CPU 310 creates the unique encryption key by inputting both the secret value “xxx” stored in the memory 340 and the encryption key to the conversion circuit group 350 (Step S603). The CPU 310 requests the main CPU 51 to read the unique encryption information from the NVRAM 60 (Step S604).

The CPU 310 acquires the unique encryption information from outside via the IF 52a (Step S605). The CPU 310 extracts the second input information by decrypting the unique encryption information by using the unique encryption key (Step S606). The CPU 310 stores the second input information in the RAM 330 (Step S607). If the unique value included in the specified area of each of the related programs match the unique value of the enable circuit 380, the CPU 310 activates a predetermined circuit (Step S608).

In the following, the effect of the secure area 300 according to the third embodiment will be described. The CPU in the secure area 300 creates a unique value obtained by converting the secret value included in the first input information, sets the created unique value in the specified area of each of the programs included in the second input information, and sets the unique value in the enable circuit 380. When the CPU 310 decrypts and executes the unique encryption information acquired from the NVRAM 60, the CPU 310 inputs each of the programs to the enable circuit 380 and activates the predetermined circuit and performs the process only when the unique value is included in the specified area of each of the programs. Consequently, for example, if the unique encryption information stored in the NVRAM 60 is altered, because the unique value is not included in the specified area of each of the programs, it is possible to improve safety while maintaining flexibility in the secure area 300.

### [d] Fourth Embodiment

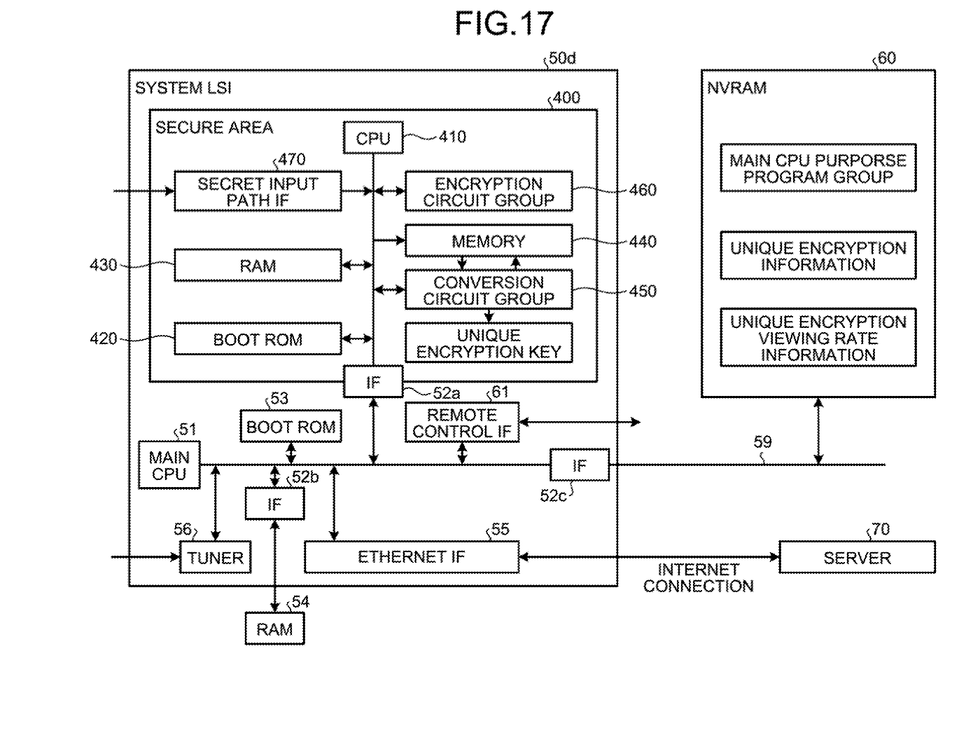

The configuration of a system LSI according to a fourth embodiment will be described. FIG. 17 is a schematic diagram illustrating an example of a system LSI according to a fourth embodiment. As illustrated in FIG. 17, a system LSI 50d includes the main CPU 51, the IFs 52a, 52b, and 52c, the Boot ROM 53, the RAM 54, the Ethernet IF 55, the Tuner 56, a remote control IF 61, and a secure area 400. In the fourth embodiment, the drawings of the decompression processing circuit and the graphic circuit are omitted. The system LSI 50d is connected to the NVRAM 60. Furthermore, the system LSI 50d is connected to a server 70 via the Ethernet IF 55.

Descriptions of the main CPU 51, the IFs 52a, 52b, and 52c, the Boot ROM 53, the RAM 54, the Ethernet IF 55, and the Tuner 56 are the same as those described in the first embodiment. The remote control IF 61 is an IF that receives an instruction from a remote control device operated by a viewer or the like.

The NVRAM 60 stores therein the main CPU program group and the unique encryption information. The unique encryption information is the second input information that is encrypted by the unique encryption key. The second input information according to the fourth embodiment includes therein, in addition to the information described in the first embodiment, a viewing rate survey program.

In the fourth embodiment, a description will be given of a process when the secure area 400 executes the viewing rate survey program. The processes performed in the other areas in the secure area 400 are the same as those performed in the secure area 100 according to the first embodiment described above.

The configuration of the secure area 400 will be described. As illustrated in FIG. 17, the secure area 400 includes a CPU 410, a Boot ROM 420, a RAM 430, a memory 440, a conversion circuit group 450, an encryption circuit group 460, and a secret input path IF 470.

The basic processes performed by the CPU 410, the Boot ROM 420, the RAM 430, the memory 440, the conversion circuit group 450, the encryption circuit group 460, and the secret input path IF 470 are the same as those performed by the devices described in the first embodiment. In a description below, a description will be given of an example of a process performed on the secure area 400 in which the viewing rate survey program included in the unique encryption information is executed.

The CPU 410 acquires the unique encryption information and inputs the unique encryption information and the unique encryption key to the encryption circuit group 460, whereby the CPU 410 decrypts the unique encryption information and extracts the second input information. For example, in the second input information, the management program, the B-CAS program, the viewing rate survey program, the Transport Layer Security (TLS) program, the IF program, and the like are included. The CPU 410 loads the management program, the viewing rate survey program, the TLS program, and the IF program in the RAM 430 and executes the programs.

A description will be given of an example of the operation of the CPU 410 that executes the viewing rate survey program. The CPU 410 uses date and time information, the identification number of the work key Kw, and the channel identification number that are included in ECM. For example, the CPU 410 executes the ECM process by executing the B-CAS program, acquires the date and time information, the identification number of the work key Kw, and the channel identification number, and sequentially accumulates the acquired data in the RAM 430.

By using the unique encryption key created based on the secret value “xxx” stored in the memory 440 and the encryption key, the CPU 410 creates the unique encryption viewing rate information by encrypting the date and time information, the identification number on the work key Kw, and the channel identification number that are accumulated in the RAM 430. The CPU 410 requests the main CPU 51 to store the unique encryption viewing rate information in the NVRAM 60. By repeatedly performing the related processes, the CPU 410 can record a TV program viewed by a viewer. Furthermore, the CPU 410 may also add, to the unique encryption viewing rate information, certain information, such as information that uniquely identifies the secure area, information that uniquely identifies a receiving apparatus, or the like, that specifies a viewer.

The unique encryption viewing rate information stored in the NVRAM 60 is preferably notified to the external server 70 via the secure area 400. For example, the CPU 410 may also execute the TLS program and notify the server 70 of the unique encryption viewing rate information and the information on the unique encryption key in accordance with the TLS protocol. The unique encryption viewing rate information secured in accordance with the TLS protocol is notified to the main CPU 51 by the CPU 410. The main CPU 51 converts the unique encryption viewing rate information and the unique encryption key to information used in the form of the Internet and then notifies the server 70 of the converted information via the Ethernet IF 55. Furthermore, the secure area 400 may also perform data communication with the server 70 by using a safe communication protocol that is other than TLS.

Incidentally, if the CPU 410 in the secure area 400 executes the viewing rate survey program, repeatedly executes the processes described above, and accumulates the unique encryption viewing rate information in the NVRAM 60, the amount of data of the unique encryption viewing rate information becomes large. Thus, the CPU 410 does not need to create the unique encryption viewing rate information every time the CPU 410 acquires an ECM. For example, the CPU 410 may also create the unique encryption viewing rate information at an interval of a predetermined number of times of acquisition of ECMs. Alternatively, if the channel identification number and the identification number of the work key Kw have been changed when compared with the channel identification number and the identification number of the work key Kw obtained last time, the CPU 410 may also create the unique encryption viewing rate information. By the CPU 410 performing the process described above, it is possible to prevent the amount of data of the unique encryption viewing rate information to become large.

In the following, a description will be given of the flow of a process of adding and updating the content of the NVRAM 60 in a path other than the secret input path IF 470. For example, if the write inhibit flag is ON, the CPU 410 acquires the information from the path other than the secret input path IF 470.

The server 70 prepares an additional program that is used in the secure area 400. In a description below, the program that is used in the secure area 400 and that is prepared by the server 70 is appropriately referred to as an additional program. The server 70 secures the additional program in accordance with the TLS protocol and transmits the additional program to the system LSI 50d in the receiving apparatus via the Internet.

The CPU 410 in the secure area 400 executes the management program and operates, under the management of the related management program, the TLS program, the decryption program, the encryption program, and the IF program.

If the main CPU 51 receives a secured additional program from the server 70, the main CPU 51 inputs the subject additional program to the secure area 400. If the CPU 410 accepts the secured additional program, the CPU 410 executes the decryption program and decrypts the additional program. The decryption key used when the additional program is decrypted may also be used in common with the secure area 400 and the server 70.

The CPU 410 executes the encryption program after having decrypted the additional program and then encrypts the additional program by the unique encryption key. The CPU 410 requests the main CPU 51 to store the information on the additional program that has been encrypted by the unique encryption key in the NVRAM 60. Furthermore, if the CPU 410 decrypts the additional program, the CPU 410 may also insert a unique value into the specified area of the additional program. The process of inserting the unique value in the specified area of the additional program is the same as that described in the third embodiment.

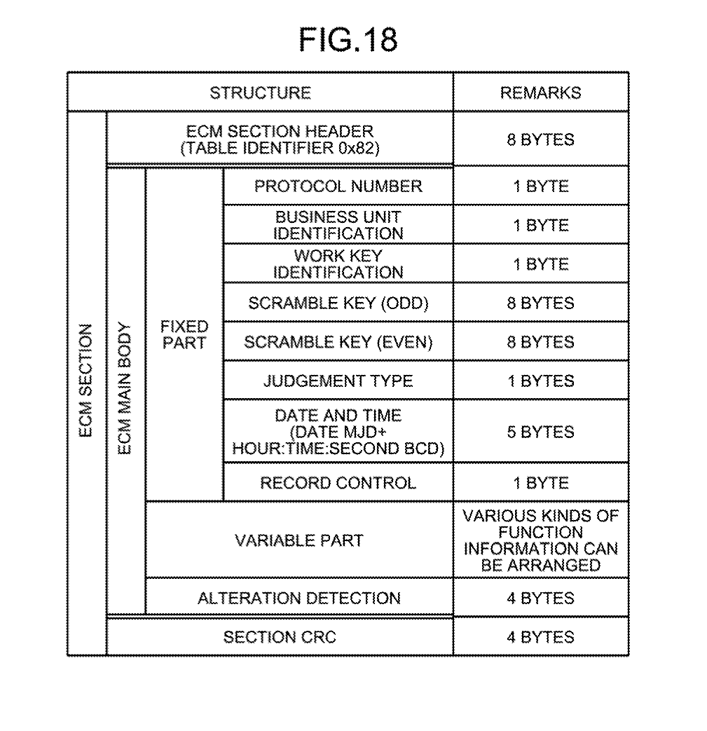

In the following, an example of the data structure of the ECM described above will be described. FIG. 18 is a schematic diagram illustrating the data structure of the ECM. As illustrated in FIG. 18, this ECM includes the ECM section header, the ECM main body, and the section CRC. The ECM main body includes a fixed part, a variable part, and alteration detection. The fixed part includes a protocol number, a business unit identification, a work key identification, a scramble key (Odd), a scramble key (Even), a judgement type, date and time, and record control.

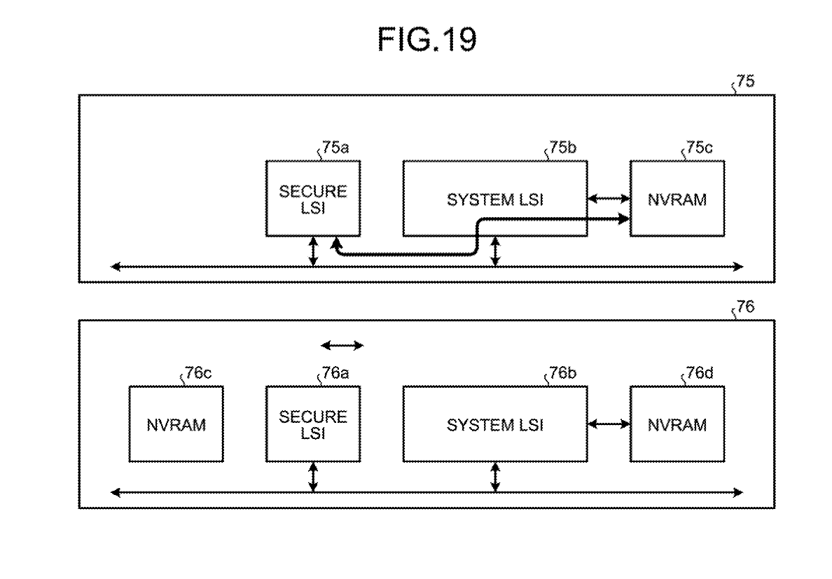

In the following, a configuration example of the other system will be described. In the first to the fourth embodiments described above, the system LSI includes the secure area and system LSI and the secure area commonly use the NVRAM; however, the embodiment is not limited to this. FIG. 19 is a schematic diagram illustrating a configuration example of the other system. For example, as indicated by a system example 75, a secure LSI 75a associated with the secure area may also be present outside a system LSI 75b and the secure LSI 75a may also acquire various kinds of data from an NVRAM 75c via the system LSI 75b.

Furthermore, as indicated by a system example 76, a secure LSI 76a associated with the secure area is present outside a system LSI 76b. Then, the secure LSI 76a may also be connected to an NVRAM 76c and the system LSI 76b may also be connected to an NVRAM 76d.

According to an aspect of an embodiment of the present invention, even if the storage capacity of a nonvolatile memory in a secure area is small, it is possible to implement a plurality of programs.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A security device comprising:
a processor that is included in a secure area; and
a first memory with storage capacity less than a predetermined amount, wherein
the processor decrypts, when encrypted first information and encrypted second information are input from a secret input path, the first information and the second information and stores the first information in the first memory, and
the processor encrypts, by using an encryption key obtained based on the decrypted first information, the decrypted second information and makes a request to store the encrypted second information in a second memory that is present outside the secure area.

2. The security device according to claim 1, wherein
the first information includes unique information,
the second information includes program information for allowing the processor to execute a predetermined process, and
the processor creates the encryption key based on the unique information in the first information that is stored in the first memory and encrypts the decrypted second information by using the created encryption key.

3. The security device according to claim 2, wherein
the processor encrypts the second information by using the encryption key after having added the unique information stored in the first memory to the second information and makes a request to store the second information in the second memory, and
when the processor acquires the second information stored in the second memory, the processor decrypts the acquired second information by using the encryption key and allows a specific portion in the secure area to be operated, when the unique information is included in the decrypted second information.

4. The security device according to claim 3, wherein
when the processor acquires the second information stored in the second memory, the processor decrypts the acquired second information by using the encryption key and allows a program included in the second information to be executed, when the unique information is included in the decrypted second information.

5. The security device according to claim 1, further comprising a third memory, included in the secure area, that stores therein information for determining whether writing with respect to the first memory is to be allowed, wherein
the processor stores, in the third memory after having written the first information to the first memory, information indicating that the writing with respect to the first memory is not allowed.

6. The security device according to claim 5, wherein
the first memory is a One Time Rom that does not allow once written information to be updated, and
when information indicating that the writing with respect to the first memory is allowed is stored in the third memory, the processor adds, as a postscript, information acquired from outside the secure area to the first memory.

7. The security device according to claim 5, wherein the third memory is a One Time Rom that does not allow once written information to be updated.

8. The security device according to claim 5, wherein the first memory and the third memory are One Time Roms that do not allow once written information to be updated.

9. The security device according to claim 5, wherein
the processor acquires information from the secret input path, when information indicating that the writing with respect to the first memory is allowed is stored in the third memory, and
the processor acquires information from an input path other than the secret input path and executes a process in accordance with the acquired information, when the information indicating that the writing with respect to the first memory is not allowed is stored in the third memory.

10. The security device according to claim 1, wherein the first information is one and only information.

11. A control method comprising:
decrypting, when encrypted first information and encrypted second information are input from a secret input path, the first information and the second information, using a processor included in secure area;
storing the decrypted first information in the first memory with storage capacity less than a predetermined amount, using the processor;
encrypting the decrypted second information, by using an encryption key obtained based on the decrypted first information, using the processor; and
making a request to store the encrypted second information in a second memory that is present outside the secure area, using the processor.
